(19) United States
(12) Patent Application Publication
(10) Pub. No.: US 2014/0293871 A1
(43) Pub. Date: Oct. 2, 2014

(54) MOBILE COMMUNICATION NETWORK AND MOBILE COMMUNICATION METHOD USING THE SAME

(71) Applicant: ELECTRONICS AND TELECOMMUNICATIONS RESEARCH INSTITUTE, Daejeon (KR)

(72) Inventor: Heeyoung JUNG, Daejeon (KR)

(73) Assignee: ELECTRONICS AND TELECOMMUNICATIONS RESEARCH INSTITUTE, Daejeon (KR)

(21) Appl. No.: 14/081,090

(22) Filed: Nov. 15, 2013

(30) Foreign Application Priority Data
Mar. 27, 2013 (KR) 10-2013-0033044

(51) Int. Cl. H04W 40/20

(52) U.S. Cl. CPC H04W 40/20
USPC 370/328

(57) ABSTRACT

A mobile communication network includes a plurality of access nodes that control wireless access of a mobile terminal, a location server that stores location information of a mobile terminal that has wireless access to the access node, and a gateway that controls interlock with the Internet, wherein the mobile terminal that is connected to the access node communicates with another mobile terminal using location information that is stored at the location server or communicates with an Internet terminal that is connected to the Internet.

### CROSS-REFERENCE TO RELATED APPLICATION

This application claims priority to and the benefit of Korean Patent Application No. 10-2013-0033044 filed in the Korean Intellectual Property Office on Mar. 27, 2013, the entire contents of which are incorporated herein by reference.

### BACKGROUND OF THE INVENTION

1. Field of the Invention

The present invention relates to a mobile communication network and a communication method using the same. More particularly, the present invention relates to an identifier-based next generation mobile communication network having a flat structure and a communication method using the same.

2. Description of the Related Art

A conventional mobile communication network uses identifier-based mobile communication network technology and address-based Internet protocol (hereinafter referred to as “IP”) network technology together.

FIG. 1 is a diagram illustrating a configuration of a conventional 3GPP mobile communication network. The conventional 3GPP mobile communication network is formed with long term evolution (LTE), which is wireless segment technology, and evolved packet core (EPC) technology, which is core network technology. Further, an EPC 60 is formed with a serving gateway (S-GW) 30 for transporting a packet with 3GPP-based wireless technology, a packet data network gateway (P-GW) 50 for transporting a packet with non-3GPP-based wireless technology, and a mobility management entity (MME) 40 for mobility support with LTE wireless technology. For convenience of description, FIG. 1 illustrates that a mobile terminal 11 has wireless access to an evolved node B (eNB) 21 through LTE, which is 3GPP-based wireless technology, and a mobile terminal 12 has wireless access to a base station/access point (AP) 22 through non-3GPP-based wireless technology (e.g., WIFI, WIMAX, etc.). The EPC 60 generally uses IP network technology and uses tunneling technology (GTP tunnel 71 or GRE tunnel 72) between the P-GW 50 and the S-GW 30 for packet transport and mobility management in a core network. The mobile terminals 11 and 12 communicate with the Internet 80 through the P-GW 50.

The mobile communication network structure of FIG. 1 reduces a layer, compared with existing second generation and third generation networks, but has the same hierarchical structure as that of the base stations 21 and 22, the S-GW 30, and the P-GW 50. However, such a hierarchical structure has a high network construction cost and operation cost CAPEX/OPEX, and has an inefficiency problem in rapidly increasing data traffic, which is the hottest issue of recent mobile communication. Nowadays, in order to solve this, complete flat structure technology is suggested, and it is expected that a conventional EPC network will evolve in a complete flat structure, as shown in FIG. 2.

FIG. 2 is a diagram illustrating a mobile communication network of an evolved flat structure.

The mobile communication network of a flat structure of FIG. 2 includes a plurality of access nodes (AN) 71-75 and a gateway 99 that interlocks with the Internet. In a next generation mobile communication network of a flat structure, a network function is distributed to the access nodes 71-75, and the distributed access nodes 71-75 each have a structure that replaces a partial function in which an existing MME 40, S-GW 30, and P-GW 50 perform as well as a wireless access function of the mobile terminals 11 and 12. The mobile communication network of a flat structure of FIG. 2 has a merit, compared with an existing hierarchical structure, but has a technical issue that should still solve. Specifically, technical issues that the mobile communication network of a flat structure has are how to integrate mixed identifier-based communication and address-based communication, how to perform mobility management between the distributed access nodes 71-75, and how to efficiently support interlocking with the Internet 80.

### SUMMARY OF THE INVENTION

The present invention has been made in an effort to provide a flat structure-based mobile communication network that efficiently provides single identifier-based communication, mobility management between access nodes, and interlock with the Internet, and a communication method using the same.

An exemplary embodiment of the present invention provides a mobile communication network. The mobile communication network includes: a plurality of access nodes that control wireless access of a mobile terminal; a location server that stores location information of a mobile terminal that has wireless access to the access node; and a gateway that controls interlock with the Internet, wherein the mobile terminal that has access to the access node communicates with another mobile terminal using location information that is stored at the location server or communicates with an Internet terminal that is connected to the Internet.

Another embodiment of the present invention provides a mobile communication method. The mobile communication method includes: having, by a first mobile terminal, wireless access to a first access node of a plurality of access nodes that control wireless access of a mobile terminal; having, by a second mobile terminal, wireless access to a second access node of the plurality of access nodes; acquiring, by the first mobile terminal, location information of the second mobile terminal from a location server; and transmitting, by the first mobile terminal, a packet to the second mobile terminal with an Internet protocol (IP) routing method using the acquired location information.

Yet another embodiment of the present invention provides a mobile communication method. The mobile communication method includes: having, by a first mobile terminal, wireless access to a first access node of a plurality of access nodes that control wireless access of a mobile terminal in a mobile communication network; acquiring, by an Internet terminal that is connected to Internet, a virtual IP address including phone number information of the first mobile terminal through a naming system; transmitting, by the Internet terminal, a packet with an IP routing method using the acquired virtual IP address to a gateway that charges interlock between the Internet and the mobile communication network; acquiring, by the gateway, an IP address of the first mobile terminal from a location server using phone number information of the virtual IP address; and forwarding, by the gateway, the received packet to the first mobile terminal with an IP routing method using the acquired IP address.

### BRIEF DESCRIPTION OF THE DRAWINGS

FIG. 1 is a diagram illustrating a configuration of a conventional 3GPP mobile communication network.

FIG. 2 is a diagram illustrating a configuration of a mobile communication network of a flat structure that is evolved into a flat structure.

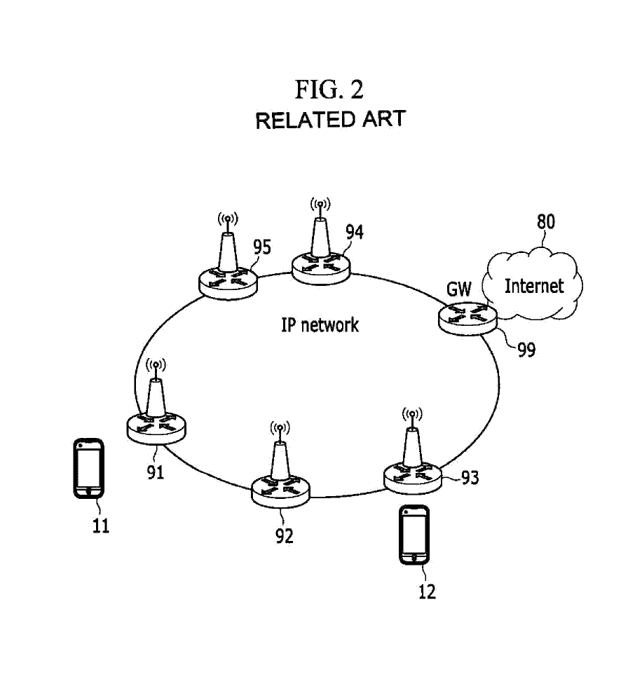

FIG. 3 is a diagram illustrating a mobile communication network of a flat structure according to an exemplary embodiment of the present invention.

FIG. 4 is a flowchart illustrating a connection procedure in which a first mobile terminal has wireless access to a mobile communication network.

FIG. 5 is a flowchart illustrating a packet transport procedure when communication between first and second mobile terminals is performed within a mobile communication network.

FIG. 6 is a flowchart illustrating a packet transport procedure from a first mobile terminal to an Internet terminal within a mobile communication network.

FIG. 7 is a flowchart illustrating a packet transport procedure from an Internet terminal to a first mobile terminal within a mobile communication network.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a mobile terminal (MT) may indicate a terminal, a mobile station (MS), an advanced mobile station (AMS), a high reliability mobile station (HR-MS), a subscriber station (SS), a portable subscriber station (PSS), an access terminal (AT), and user equipment (UE) and may include an entire function or a partial function of the terminal, the MS, the AMS, the HR-MS, the SS, the PSS, the AT, and the UE.

Further, an access node (AN) may indicate a base station (BS), an advanced base station (ABS), a high reliability base station (HR-BS), a node B, an evolved node B (eNodeB), an access point (AP), a radio access station (RAS), a base transceiver station (BTS), a mobile multihop relay base station (MMR-BS), a relay station (RS) that performs a function of the BS, and a high reliability relay station (HR-RS) that performs a function of the BS, and may include an entire function or a partial function of the BS, the ABS, the HR-BS, the nodeB, the eNodeB, the AP, the RAS, the BTS, the MMR-BS, the RS, and the HR-RS.

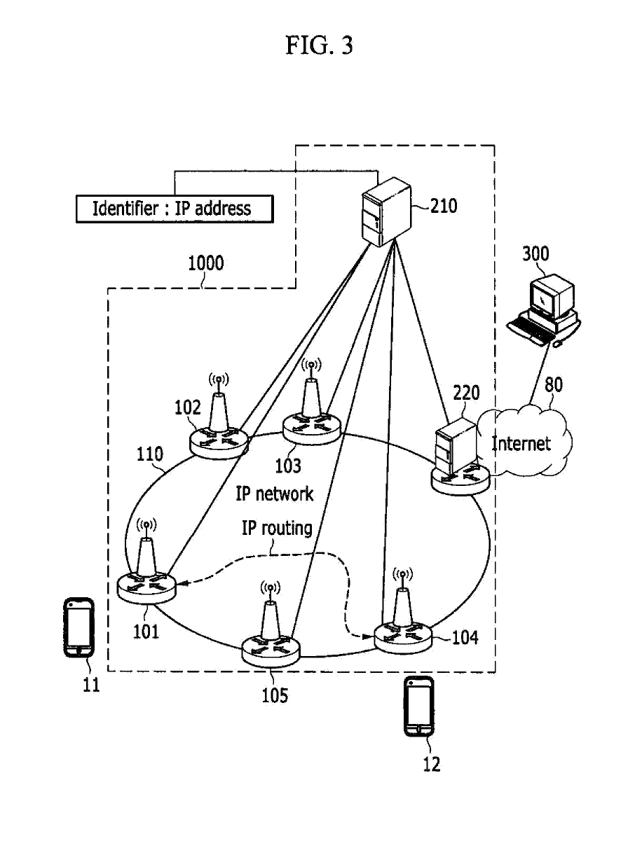

FIG. 3 is a diagram illustrating a mobile communication network of a flat structure according to an exemplary embodiment of the present invention. A mobile communication network 1000 of a flat structure of FIG. 3 has an identifier-based communication structure.

The mobile communication network 1000 of a flat structure includes a plurality of distributed access nodes 101-105, a gateway 220 for interlock with the Internet 80, and a location server 210 for mobility management in the mobile communication network.

The location server 210 stores and provides identifiers and location information (IP address) of each of the first and second mobile terminals 11 and 12. Specifically, the location server 210 registers, maintains, and manages mapping information (identifier: IP address) between identifiers and locations of each of first and second mobile terminals 11 and 12 within the mobile communication network 1000. Here, the identifiers of the first and second mobile terminals 11 and 12 may use an identifier (E.164 phone number, international mobile subscriber identity (IMSI), temporary mobile subscriber identity (TMSI), and international mobile equipment identity (IMEI)) that has already been used in an existing mobile communication network, or may use an identifier of a new form. Location information may be an IP address corresponding to a connection point within the mobile communication network 1000 to which the mobile terminals 11 and 12 are connected.

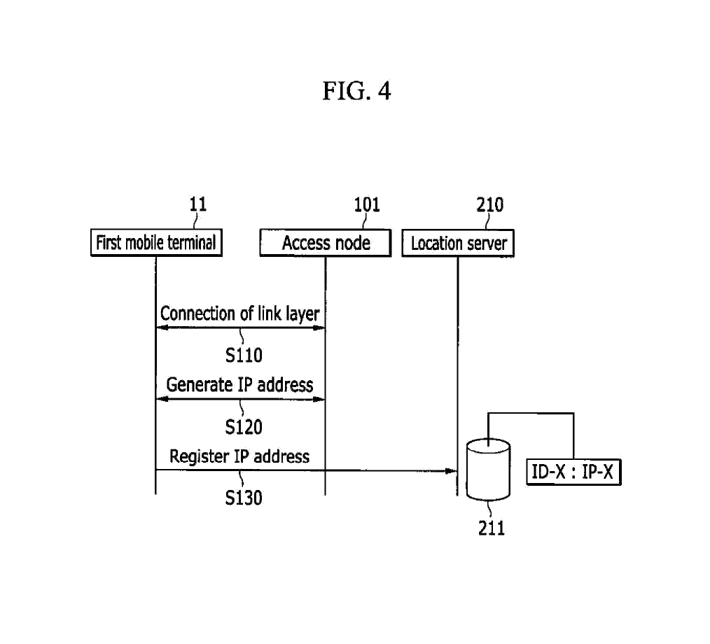

The access nodes 101-105 are each responsible for signal processing, packet buffering, and forwarding in a wireless interface and an access portion. Specifically, the access nodes 101-105 are generally mutually connected through an IP technology-based core network 110. The access nodes 101-105 control wireless access to the mobile communication network 1000 of the first mobile terminal 11 and the second mobile terminal 12. Hereinafter, for convenience of description, it is exemplified that the first mobile terminal 11 has wireless access to the access node 101 of the access nodes 101-105 using wireless communication technology (LTE, WiFi, WiMAX, etc.), and the second mobile terminal 12 has wireless access to the access node 104 of the access nodes 101-105 using wireless communication technology (LTE, WiFi, WiMAX, etc.). In the mobile communication network 1000, when wanting to transmit a packet from the first mobile terminal 11 to another mobile terminal (e.g., the second mobile terminal 12), the access node 101 to which the first mobile terminal 11 has wireless access forwards a packet of the first mobile terminal 11 to the access node 104 to which the second mobile terminal 12 has wireless access with an IP routing method using location information (IP address) of the second mobile terminal 12 that is stored at the location server 210. When wanting to transmit a packet from the mobile terminal (e.g., the first mobile terminal 11) within the mobile communication network 1000 to the Internet terminal 300 that is connected to the Internet 80, the access node 101 forwards a packet of the first mobile terminal 11 to the gateway 220 that is connected to the Internet 80 with an IP routing method. A packet transport procedure will be described in detail with reference to FIGS. 4 to 7.

The gateway 220 is responsible for interlocking with the Internet 80 and signal processing, packet buffering, and forwarding for interlock. Specifically, when wanting to transmit a packet from an Internet terminal 300 to the mobile terminals 11 and 12 within the mobile communication network, the gateway 220 forwards a packet of the Internet terminal 300 to the access nodes 101 and 104 to which the mobile terminals 11 and 12 had wireless access with an IP routing method using location information (IP address) of the mobile terminals 11 and 12 that are stored at the location server 210. When transmitting a packet from the mobile terminals 11 and 12 within the mobile communication network 1000 to the Internet terminal 300, the gateway 220 forwards the packet of the mobile terminals 11 and 12 that is forwarded from the access nodes 101 and 104 to which the mobile terminals 11 and 12 had wireless access to the Internet terminal 300. A packet transport procedure will be described in detail with reference to FIGS. 4 to 7.

FIG. 4 is a flowchart illustrating a connection procedure in which the first mobile terminal 11 has wireless access to the mobile communication network 1000 of FIG. 3. FIG. 4 illustrates a wireless access connection procedure of the first mobile terminal 11 for convenience of description, but a wireless access connection procedure of the second mobile terminal 12 is the same as the connection procedure of the first mobile terminal 11.

When the first mobile terminal 11 is newly connected to the mobile communication network 1000 or when the first mobile terminal 11 changes a connection point of the mobile communication network 1000, a connection procedure of a data link layer is first performed (S110). The connection procedure of the data link layer may be different according to link characteristics of each communication technology (e.g., LTE, WiFi, WiMAX, etc.).

When a connection procedure is complete in a link layer, an IP address generation procedure for IP routing is performed (S120). Specifically, the first mobile terminal 11 does not have a permanent IP address, and whenever the first mobile terminal 11 is connected to the mobile communication network 1000, the first mobile terminal 11 is allocated a new address corresponding to a network subnet. In this case, an IP address may be acquired by a dynamic allocation method (DHCP) or address auto-configuration, and the IP address may be changed when a network connection point, of the first mobile terminal 11 is changed.

When generation of the IP address is complete, the first mobile terminal 11 registers an identifier ID-X thereof and a newly acquired IP address IP-X corresponding to location information in a database 211 within the location server 210 (S130).

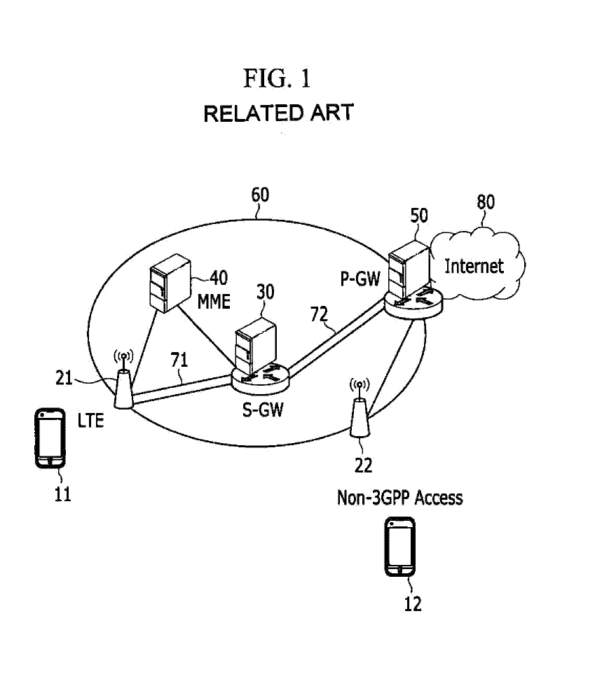

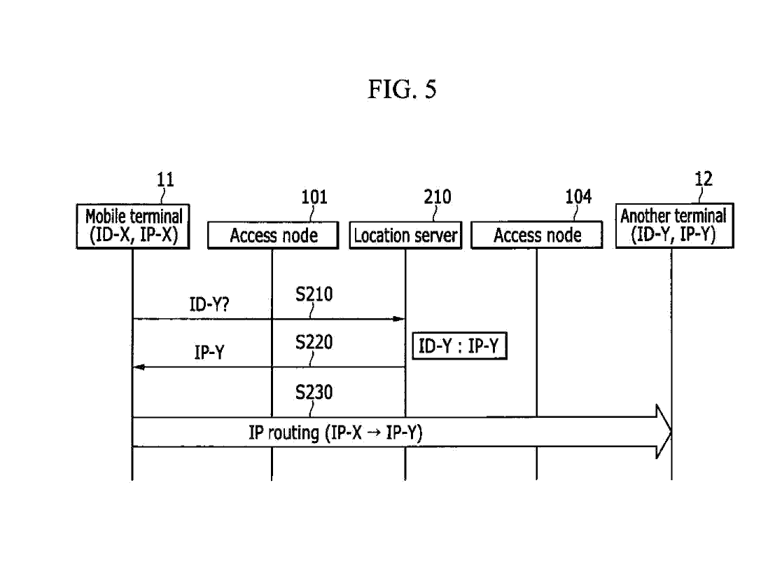

FIGS. 5 to 7 are flowcharts illustrating a packet transport procedure. The core network 110 of the mobile communication network 1000 transports a packet by a standard IP routing method instead of a tunneling method that is used in an existing EPC of FIG. 1.

FIG. 5 is a flowchart illustrating a packet transport procedure when communication between mobile hosts 11 and 12 is performed within a mobile communication network. For convenience of description, FIG. 5 illustrates a case where the first mobile terminal 11 wants to communicate with the second mobile terminal 12.

Because the first mobile terminal 11 first wants to communicate with the second mobile terminal 12, the first mobile terminal 11 requests an IP address of the second mobile terminal 12 from the location server 210 using an identifier ID-Y of the second mobile terminal 12 (S210).

The location server 210 provides an IP address IP-Y of the second mobile terminal 12 to the first mobile terminal 11 using mapping information between a previously registered identifier ID-Y and the IP address of the second mobile terminal 12 (S220).

The first mobile terminal 11 transmits a packet using the received IP address information of the second mobile terminal 12. In this case, packet transmission is performed through standard IP routing instead of a tunneling method like an existing EPC (S230).

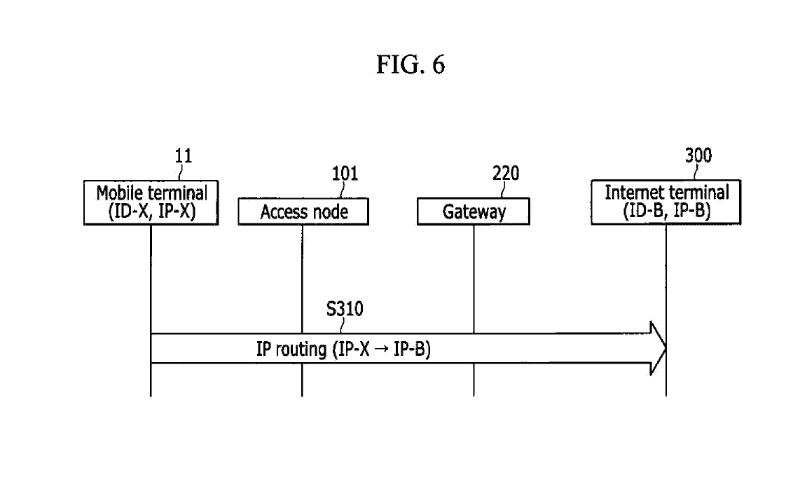

In communication between the mobile communication network 1000 and the Internet 80, when the mobile terminals 11 and 12 within the mobile communication network 1000 want to communicate with a specific terminal 300 of the Internet 80, communication is performed through a procedure of FIG. 6.

In FIG. 6, for convenience of description, a packet transport procedure from the first mobile terminal 11 within the mobile communication network 1000 to the Internet terminal 300 that is connected to the Internet 80 is illustrated.

The first mobile terminal 11 acquires an IP address IP-B of the Internet terminal 300 through a domain name system (DNS). The first mobile terminal 11 transmits a packet to the Internet terminal 300 through standard IP routing based on the acquired IP address IP-B of the Internet terminal 300 (S310).

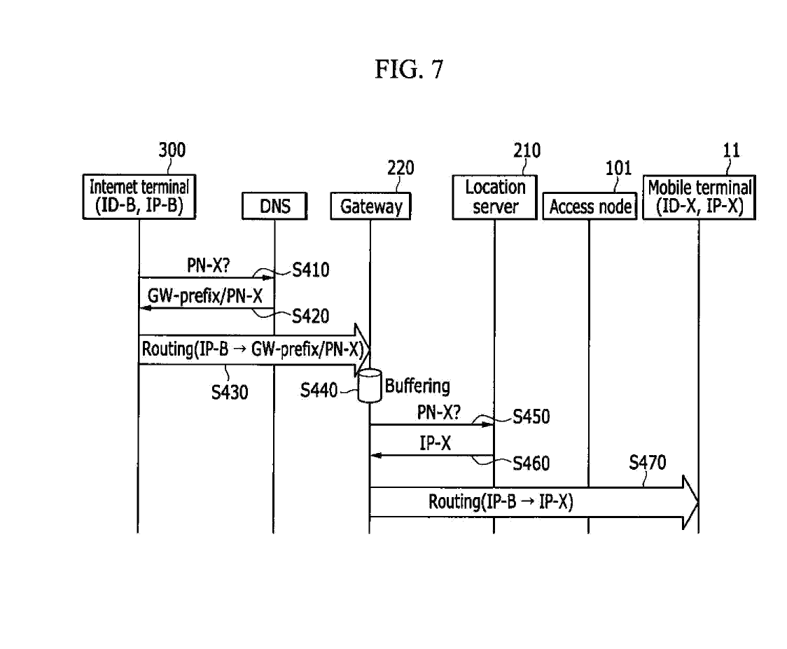

In communication between the mobile communication network 1000 and the Internet 80, when the Internet terminal 300 transmits a packet to the mobile terminals 11 and 12 within the mobile communication network 1000, a packet is transported by a procedure of FIG. 7.

For convenience of description, FIG. 7 illustrates a packet transport procedure from the Internet terminal 300 to the first mobile terminal 11 within the mobile communication network 1000, and a case where identifier information ID-X of the first mobile terminal 11 that is stored at the location server 210 is a phone number (PN) of the first mobile terminal 11 is illustrated.

First, the Internet terminal 300 obtains a virtual IP address GW-prefix/PN-X of the first mobile terminal 11 through a naming system such as a DNS using already known identifier information ID-X of the first mobile terminal 11 (S410 and S420). In FIG. 7, it is assumed that a virtual IP address GW-prefix/PN-X is acquired using identifier information ID-X, i.e., phone number information PN-X, of the first mobile terminal 11. In this case, an available virtual IP address is formed using prefix information of the mobile communication network 1000 and phone number information PN of a mobile terminal. The virtual IP address may be differently designed according to an embodiment environment. For example, when an IP address system has enough address space like IPv6, phone number information PN may be included in the IPv6 address space. Alternatively, when an IP address system has little address space like IPv4, only an address of the gateway 220 is included in the IP address space, and identifier information, i.e., phone number information PN, may be designed to be, included in other areas such as an option header.

The Internet terminal 300 transports a packet to the first mobile terminal 11 using the acquired virtual IP address information GW-prefix/PN-X. In this case, IP routing from the Internet 80 to the gateway 220 of the mobile communication network 1000 is performed based on prefix information of the acquired virtual IP address GW-prefix/PN-X (S430).

The gateway 220, having received the packet, buffers the packet (S440). Thereafter, the gateway 220 inquiries a location, i.e., IP address information IP-X, of the first mobile terminal 11 from the location server 210 using phone number information PN-X within the virtual IP address GW-prefix/PN-X (8450).

The location server 210 provides IP address information IP-X of the first mobile terminal 11 to the gateway 220 using previously registered information (S460).

The gateway 220 transports a packet to the first mobile terminal 11 through standard IP routing using the acquired IP address information IP-X of the first mobile terminal 11 (S470).

FIG. 7 illustrates a case where the identifier information ID-X of the first mobile terminal 11 that is stored at the location server 210 is phone number information PN-X of the first mobile terminal 11, but when identifier information ID-X of the first mobile terminal 11 that is stored at the location server 210 is information of another form instead of phone number information PN-X, after a process of converting phone number information PN-X within the virtual IP address GW-prefix/PN-X to an identifier information ID-X form that is stored at the location server 210 is additionally performed before step S450, the gateway 220 inquiries a location, i.e., IP address information IP-X of the first mobile terminal 11 from the location server 210 using the identifier information ID-X of the first mobile terminal 11 at step S450.

According to the present invention, as in a 3GPP EPC network of FIG. 1, by unifying an environment in which identifier-based communication and IP address-based communication are mixed into identifier-based communication, an efficient identifier-based communication structure and ID/locator separation (LIS) can be provided.

Further, according to the present invention, by replacing packet transport through tunneling (71 and 72 of FIG. 1) that is used in an existing EPC with standard IP routing, IP packet transport within a mobile communication network can be efficiently performed.

Further, according to the present invention, in unidirectional communication that is available from existing mobile communication terminals 11 and 12 only to an Internet terminal (terminal that is connected to the Internet 80), by enabling communication from an Internet terminal to the mobile terminals 11 and 12, bi-directional communication can be supported.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A mobile communication network comprising:
a plurality of access nodes that control wireless access of a mobile terminal;
a location server that stores location information of a mobile terminal that has wireless access to the access node; and
a gateway that controls interlock with the Internet,
wherein the mobile terminal that has access to the access node communicates with another mobile terminal using location information that is stored at the location server or communicates with an Internet terminal that is connected to the Internet.

2. The mobile communication network of claim 1, wherein the access node allocates an IP address to a mobile terminal that has wireless access to the access node,
the location server stores an IP address which is location information and an identifier of the mobile terminal that has wireless access to the access node, and
the IP address of the mobile terminal that is stored at the location server is changed when an access node to which the mobile terminal has wireless access is changed.

3. The mobile communication network of claim 2, wherein an identifier of the mobile terminal that is stored at the location server is one form of an E.164 phone number of ITU-T, an international mobile subscriber identity (IMSI), a temporary mobile subscriber identity (TMSI), and an international mobile equipment identity (IMEI).

4. The mobile communication network of claim 2, wherein the plurality of access nodes are connected through an Internet protocol (IP)-based core network.

5. The mobile communication network of claim 4, wherein the gateway forwards a packet of the mobile terminal that has wireless access to the access node to the Internet terminal, or forwards a packet of the Internet terminal to a mobile terminal which is a destination.

6. The mobile communication network of claim 5, wherein the plurality of access nodes comprise a first access node and a second access node,
packet transmission from a first mobile terminal that has wireless access to the first access node to a second mobile terminal that has wireless access to the second access node is performed with a process in which the first mobile terminal acquires an IP address of the second mobile terminal from the location server using an identifier of the second mobile terminal, and a process in which the first mobile terminal transmits a packet to the second mobile terminal with an IP routing method using the acquired IP address.

7. The mobile communication network of claim 6, wherein packet transmission from the first mobile terminal to the Internet terminal is performed with a process in which the first mobile terminal acquires an IP address of the Internet terminal through a domain name system (DNS), and a process in which the first mobile terminal transmits a packet to the Internet terminal with an IP routing method using the acquired IP address.

8. The mobile communication network of claim 7, wherein the identifier of the mobile terminal that is stored at the location server is phone number information of the mobile terminal, and
packet transmission from the Internet terminal to the first mobile terminal is performed with a process in which the Internet terminal acquires a virtual IP address comprising phone number information of the first mobile terminal through a naming system, a process in which the Internet terminal transmits a packet to the gateway with an IP routing method using the acquired virtual IP address, a process in which the gateway acquires an IP address of the first mobile terminal from the location server using phone number information of the virtual IP address, and a process in which the gateway forwards the received packet to the first mobile terminal with an IP routing method using the acquired IP address.

9. The mobile communication network of claim 8, wherein the naming system is the DNS, and
the virtual IP address is formed with prefix information of the mobile communication network and phone number information of the mobile terminal.

10. The mobile communication network of claim 9, wherein phone number information of the mobile terminal is stored at an address area of Internet protocol version 6 (IPv6) when a version of the virtual IP address is IPv6, and
phone number information of the mobile terminal is stored at an option header area of Internet protocol version 4 (IPv4) when a version of the virtual IP address is IPv4.

11. A mobile communication method comprising:
having, by a first mobile terminal, wireless access to a first access node of a plurality of access nodes that control wireless access of a mobile terminal;
having, by a second, mobile terminal, wireless access to a second access node of the plurality of access nodes;
acquiring, by the first mobile terminal, location information of the second mobile terminal from a location server; and
transmitting, by the first mobile terminal, a packet to the second mobile terminal with an Internet protocol (IP) routing method using the acquired location information.

12. The mobile communication method of claim 11, wherein the having of, by a first mobile terminal, wireless access to a first access node comprises:
allocating, by the first access node, an first IP address to the first mobile terminal; and
registering the allocated first IP address, which is location information, together with an identifier of the first mobile terminal at the location server,
wherein the having of, by a second mobile terminal, wireless access to a second access node comprises:
allocating, by the second access node, an second IP address to the second mobile terminal; and
registering the allocated second IP address, which is location information, together with an identifier of the second mobile terminal at the location server, and
wherein the acquiring of location information of the second mobile terminal comprises acquiring, by the first mobile terminal, the second IP address of the second mobile terminal from the location server using the identifier of the second mobile terminal.

13. A mobile communication method comprising:
having, by a first, mobile terminal, wireless access to a first access node of a plurality of access nodes that control wireless access of a mobile terminal in a mobile communication network;
acquiring, by an Internet terminal that is connected to the Internet, a virtual IP address comprising phone number information of the first mobile terminal through a naming system;
transmitting, by the Internet terminal, a packet with an IP routing method using the acquired virtual IP address to a gateway that is responsible for interlocking between the Internet and the mobile communication network;
acquiring, by the gateway, an IP address of the first mobile terminal from a location server using phone number information of the virtual IP address; and
forwarding, by the gateway, the received packet to the first mobile terminal with an IP routing method using the acquired IP address.

14. The mobile communication method of claim 13, further comprising buffering, by the gateway, the received packet, before the acquiring of an IP address of the first mobile terminal.

15. The mobile communication method of claim 13, wherein the having of, by a first mobile terminal, wireless access to a first access node comprises:
allocating, by the first access node, an IP address to the first mobile terminal; and
registering the allocated IP address together with an identifier of the first mobile terminal at the location server.

16. The mobile communication method of claim 15, wherein the naming system is a domain name system (DNS),
the virtual IP address is formed with prefix information of the mobile communication network and phone number information of the first mobile terminal,
the phone number information of the first mobile terminal is stored at an address area of IPv6 when a version of the virtual IP address is IPv6, and
the phone number information of the first mobile terminal is stored at an option header area of IPv4 when a version of the virtual IP address is IPv4.

17. The mobile communication method of claim 13, wherein the plurality of access nodes are connected through an IP-based core network.

18. The mobile communication method of claim 13, further comprising:
acquiring, by the first mobile terminal, an IP address of the Internet terminal through a DNS;
transmitting, by the first mobile terminal, a packet to the gateway with an IP routing method using the acquired IP address; and
forwarding, by the gateway, the received packet to the Internet terminal with an IP routing method.
